(19) United States
(12) Patent Application Publication
(10) Pub. No.: US 2024/0349142 A1
(43) Pub. Date: Oct. 17, 2024

(54) METHOD AND APPARATUS FOR WIRELESS COMMUNICATION

(71) Applicant: Lenovo (Beijing) Limited, Beijing (CN)

(72) Inventors: Lianhai Wu, Beijing (CN); Prateek Basu Mallick, Dreieich (DE)

(73) Assignee: Lenovo (Beijing) Limited, Beijing (CN)

(21) Appl. No.: 18/580,276

(22) PCT Filed: Aug. 5, 2021
(86) PCT No.: PCT/CN2021/110850

§ 371 Date: Jan. 18, 2024

(51) Int. Cl. H04W 36/00; H04W 36/30; H04W 76/14; H04W 88/04

(52) U.S. Cl. CPC H04W 36/033; H04W 36/30; H04W 76/14; H04W 88/04

(57) ABSTRACT

Embodiments of the present disclosure relate to wireless communication in a wireless communication system. According to some embodiments of the disclosure, a method performed by a user equipment (UE) may include: accessing a base station (BS) via a Uu link; accessing the BS via a relay node in response to a channel quality of the Uu link being less than a threshold; stopping at least one of a physical layer timer and a timer associated with measurement report triggering when the at least one of the physical layer timer and a timer associated with measurement report triggering is running.

### TECHNICAL FIELD

Embodiments of the present disclosure generally relate to wireless communication technology, and more particularly to wireless communication in a wireless communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication is may support sidelink communications, in which devices (e.g., UEs) that are relatively close to each other may communicate with one another directly via an SL, rather than being linked through the BS. A relaying function based on a sidelink may be supported in a communication network. For example, a UE supporting sidelink communication may function as a relay node to extend the coverage of a BS. An out-of-coverage UE may communicate with a BS via a relay UE. In the context of the present disclosure, a UE, which functions as a relay between another UE and a BS, may be referred to a UE-to-network relay or a U2N relay.

There is a need for efficiently performing communication in a communication system supporting a U2N relay.

### SUMMARY

Some embodiments of the present disclosure provide a method performed by a user equipment (UE). The method may include: accessing a base station (BS) via a Uu link; accessing the BS via a relay node in response to a channel quality of the Uu link being less than a threshold; in response to accessing the BS via the relay node, stopping at least one of a physical layer timer and a timer associated with measurement report triggering when the at least one of the physical layer timer and a timer associated with measurement report triggering is running.

Some embodiments of the present disclosure provide a method performed by a relay node. The method may include: transmitting a release request to a user equipment (UE), wherein the UE may access a base station (BS) via the relay node, and the release request may indicate one of: a radio failure link (RLF) detection on the link between the relay node and the BS and a handover of the relay node from the BS.

In some embodiments of the present disclosure, the method may further include: in response to transmitting the release request, receiving a response message from the UE, wherein the response message indicates to release or keep a PC5 link between the UE and the relay node.

In some embodiments of the present disclosure, the method may further include: receiving, from the UE, a request to release the PC5 link between the UE and the relay node in response to the response message indicating to keep the PC5 link between the UE and the relay node.

Some embodiments of the present disclosure provide an apparatus. According to some embodiments of the present disclosure, the apparatus may include: a transceiver; and a processor coupled to the transceiver, wherein the transceiver and the processor may interact with each other so as to perform a method according to some embodiments of the present disclosure.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of a wireless communication system in accordance with some embodiments of the present disclosure;

FIG. 3 illustrates a schematic diagram of a wireless communication system in accordance with some embodiments of the present disclosure;

FIG. 4 illustrates a flow chart of an exemplary procedure of wireless communications in accordance with some embodiments of the present disclosure;

FIG. 5 illustrates a flow chart of an exemplary procedure of wireless communications in accordance with some embodiments of the present disclosure;

FIG. 6 illustrates a flow chart of an exemplary procedure of wireless communications in accordance with some embodiments of the present disclosure; and

FIG. 7 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

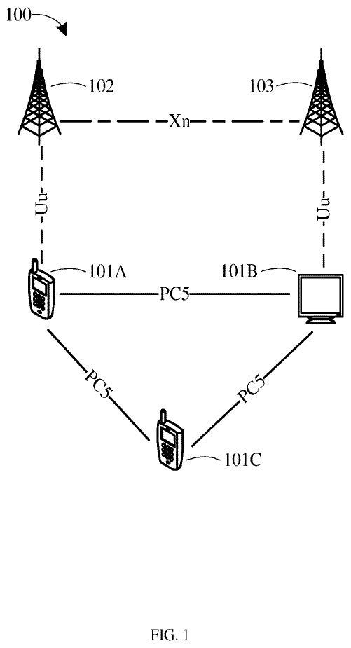

FIG. 1 illustrates a schematic diagram of a wireless communication system 100 in accordance with some embodiments of the present disclosure.

As shown in FIG. 1, the wireless communication system 100 may support sidelink communications. Sidelink communication supports UE-to-UE direct communication. In the context of the present disclosure, sidelink communications may be categorized according to the wireless communication technologies adopted. For example, sidelink communication may include NR sidelink communication and V2X Sidelink communication.

NR sidelink communications (e.g., specified in 3GPP specification TS 38.311) may refer to access stratum (AS) functionality enabling at least vehicle-to-everything (V2X) communications as defined in 3GPP specification TS 23.287 between neighboring UEs, using NR technology but not traversing any network node. V2X sidelink communications (e.g., specified in 3GPP specification TS 36.311) may refer to AS functionality enabling V2X communications as defined in 3GPP specification TS 23.285 between neighboring UEs, using evolved-universal mobile telecommunication system (UMTS) terrestrial radio access (UTRA) (E-UTRA) technology, but not traversing any network node. However, if not being specified, “sidelink communications” may refer to NR sidelink communications, V2X sidelink communications, or any sidelink communications adopting other wireless communication technologies.

Referring to FIG. 1, the wireless communication system 100 may include some base stations (e.g., BS 102 and BS 103) and some UEs (e.g., UE 101A, UE 101B, and UE 101C). Although a specific number of UEs and BSs is depicted in FIG. 1, it is contemplated that any number of UEs and BSs may be included in the wireless communication system 100.

The UEs and the BSs may support communication based on, for example, 3G, long-term evolution (LTE), LTE-advanced (LTE-A), new radio (NR), or other suitable protocol(s). In some embodiments of the present disclosure, a BS (e.g., BS 102 or BS 103) may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. A UE (e.g., UE 101A, UE 101B, or UE 101C) may include, for example, but is not limited to, a computing device, a wearable device, a mobile device, an IoT device, a vehicle, etc. Persons skilled in the art should understand that as technology develops and advances, the terminologies described in the present disclosure may change, but should not affect or limit the principles and spirit of the present disclosure.

In the example of FIG. 1, the BS 102 and the BS 103 may be included in a next generation radio access network (NG-RAN). In some embodiments of the present disclosure, the BS 102 may be a gNB and the BS 103 may be an ng-eNB.

The UE 101A and UE 101B may be in-coverage (e.g., inside the NG-RAN). For example, as shown in FIG. 1, the UE 101A may be within the coverage of BS 102, and the UE 101B may be within the coverage of BS 103. The UE 101C may be out-of-coverage (e.g., outside the coverage of the NG-RAN). For example, as shown in FIG. 1, the UE 101C may be outside the coverage of any BSs, for example, both the BS 102 and BS 103. The UE 101A and UE 101B may respectively connect to the BS 102 and BS 103 via a network interface, for example, the Uu interface as specified in 3GPP standard documents. The control plane protocol stack in the Uu interface may include a radio resource control (RRC) layer, which may be referred to as a Uu RRC. The link established between a UE (e.g., UE 101A) and a BS (e.g., BS 102) may be referred to as a Uu link. The BS 102 and BS 103 may be connected to each other via a network interface, for example, the Xn interface as specified in 3GPP standard documents. The UE 101A, UE 101B, and UE 101C may be connected to each other respectively via, for example, a PC5 interface as specified in 3GPP standard documents. The control plane protocol stack in the PC5 interface may include a radio resource control (RRC) layer, which may be referred to as a PC5 RRC. The link established between two UEs (e.g., UE 101A and UE 101B) may be referred to as a PC5 link.

Support for V2X services via the PC5 interface can be provided by, for example, NR sidelink communication and/or V2X sidelink communication. NR sidelink communication can support one of the following three types of transmission modes for a pair of a source Layer-2 identity and a destination Layer-2 identity: unicast transmission, groupcast transmission, and broadcast transmission. Sidelink communication transmission and reception over the PC5 interface are supported when the UE is either in-coverage or out-of-coverage. For example, the UE 101A, which is within the coverage of the BS 102, can perform sidelink transmission and reception (e.g., sidelink unicast transmission, sidelink groupcast transmission, or sidelink broadcast transmission) over a PC5 interface. The UE 101C, which is outside the coverage of both the BS 102 and BS 103, can also perform sidelink transmission and reception over a PC5 interface.

A UE which supports sidelink communication and/or V2X communication may be referred to as a V2X UE. A V2X UE may be a cell phone, a vehicle, a roadmap device, a computer, a laptop, an IoT (internet of things) device or other type of device in accordance with some other embodiments of the present disclosure.

As mentioned above, the relaying function based on a sidelink may be supported in a communication network. In some embodiments of the present disclosure, a UE-to-network relay is supported. For example, an in-coverage UE in communication with an out-of-coverage UE may function as a relay UE between the serving BS of the in-coverage UE and the out-of-coverage UE. In some embodiments of the present disclosure, a UE-to-UE relay is supported. For example, a UE in communication with two or more UEs (e.g., first and third UEs) may function as a relay UE, such that the first UE may communicate with the third UE via the relay UE.

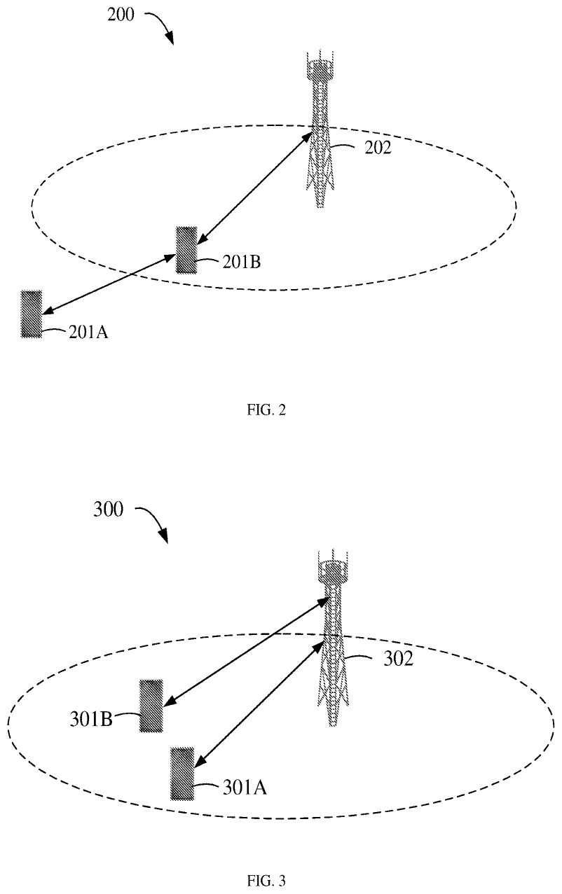

FIG. 2 illustrates a schematic diagram of a wireless communication system 200 in accordance with some embodiments of the present disclosure.

As shown in FIG. 2, the wireless communication system 200 may include a BS (e.g., BS 202) and some UEs (e.g., UE 201A and UE 201B). Although a specific number of UEs and BS is depicted in FIG. 2, it is contemplated that any number of UEs and BSs may be included in the wireless communication system 200.

Referring to FIG. 2, UE 201B may be within the coverage of BS 202. UE 201B and BS 202 may establish an RRC connection therebetween. UE 201A may be outside of the coverage of BS 202. In some examples, UE 201B may function as UE 101A or UE 101B shown in FIG. 1, and UE 201A may function as UE 101C shown in FIG. 1.

The wireless communication system 200 may support sidelink communications. For example, UE 201B may be in sidelink communication with UE 201A. A PC5 RRC connection may be established between UE 201A and UE 201B. In some embodiments of the present disclosure, UE 201A may initiate a procedure for establishing connection with BS 202 via UE 201B (i.e., UE-to-network relay). For example, UE 201A may transmit an RRC setup request to BS 202 via UE 201B. BS 202 may transmit an RRC setup message including a response to UE 201A via UE 201B. After such procedure, UE 201A may access BS 202 (e.g., a cell of BS 202) via UE 201B. This cell is referred to as the serving cell of UE 201A. UE 201A and BS 202 may establish an RRC connection therebetween, and UE 201A may have RRC states, such as an RRC_IDLE state, an RRC_INACTIVE state, and an RRC_CONNECTED state. UE 201A may also be referred to as a remote UE and UE 201B may also be referred to as a relay UE or a serving relay of UE 201A.

It should be appreciated by persons skilled in the art that although a single relay node between UE 201A and BS 202 is depicted in FIG. 2, it is contemplated that any number of relay nodes may be included.

Under certain circumstances, for example, when UE 201A moves from out-of-coverage to in-coverage, BS 202 (or the serving/source cell of UE 201A) may determine to switch UE 201A from the relay link to the Uu link. In some embodiments of the present disclosure, BS 202 (or the serving/source cell of UE 201A) may transmit an RRC reconfiguration message, which may indicate a switch to the Uu link, to UE 201A. The RRC reconfiguration message may indicate a candidate cell (e.g., the serving/source of UE 201A) for path switch (e.g., handover).

FIG. 3 illustrates a schematic diagram of a wireless communication system 300 in accordance with some embodiments of the present disclosure.

As shown in FIG. 3, the wireless communication system 300 may include a BS (e.g., BS 302) and some UEs (e.g., UE 301A and UE 301B). Although a specific number of UEs and BS is depicted in FIG. 3, it is contemplated that any number of UEs and BSs may be included in the wireless communication system 300.

Referring to FIG. 3, UE 301A and UE 301B may be within the coverage of BS 302. Each of UE 301A and UE 301B may establish a respective RRC connection with BS 302. In some examples, UE 301A and UE 301B may function as UE 101A or UE 101B shown in FIG. 1, or UE 201B shown in FIG. 2.

Under certain circumstances, for example, when UE 301A moves to the edge of the coverage area of BS 302, BS 302 (or the serving/source cell of UE 301A) may determine to switch UE 301A from the source Uu link to a relay link. In some embodiments of the present disclosure, BS 302 may instruct 301A to establish a connection with UE 301B. For example, BS 202 (or the serving/source cell of UE 301A) may transmit an RRC reconfiguration message, which may indicate a switch to a relay node, to UE 301A. The RRC reconfiguration message may indicate a candidate relay (e.g., UE 301B) for path switch (e.g., handover). UE 301A may then access BS 302 via UE 301B (for example, similar to FIG. 2 where UE 201A may access BS 202 via UE 201B).

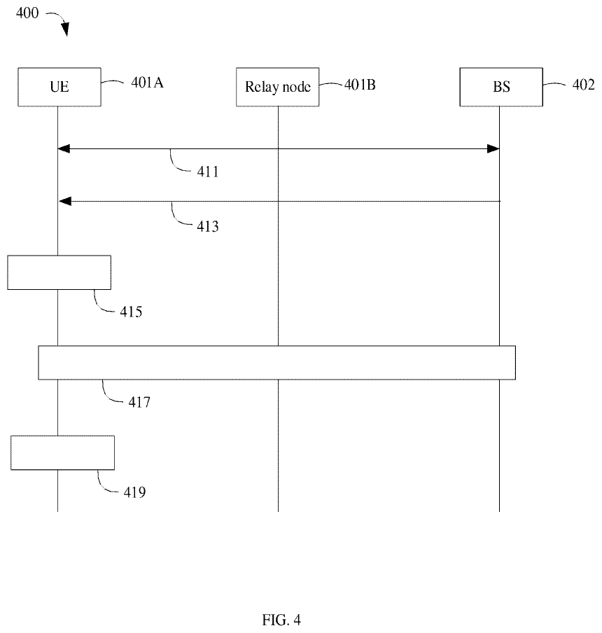

FIG. 4 illustrates a flow chart of an exemplary procedure 400 of wireless communications in accordance with some embodiments of the present disclosure. Details described in all of the foregoing embodiments of the present disclosure are applicable for the embodiments shown in FIG. 4.

In operation 411, UE 401A may access BS 402 (e.g., a cell of BS 402) via the Uu interface.

In some embodiments of the present disclosure, BS 402 (e.g., the cell(s) of BS 402) may implicitly or explicitly indicate whether a relay function is supported or not, that is, whether a remote UE is allowed to access BS 402 via a relay node (e.g., a relay UE).

In some examples, BS 402 may broadcast an indication of whether the relay function is supported or not in a system information block (SIB) (e.g., SIB1). For instance, SIB1 may include an SL-relay-support information element (IE), which may be represented as: “SL-relay-support IE=ENUMERATED {true}.” When an SIB1 includes the SL-relay-support IE, it means that the current cell supports a sidelink relay. Otherwise, when the IE is absent from the SIB1, the current cell does not support a sidelink relay (U2N relay).

In some examples, BS 402 may use separate indications for a layer 2 (L2) U2N relay and a layer 3 (L3) U2N relay. For instance, an SL-L2-relay-support IE and an SL-L3-relay-support IE may be employed, which may be represented as: “SL-L2-relay-support IE=ENUMERATED {true}” and “SL-L3-relay-support IE=ENUMERATED {true}.” When an SIB1 includes the SL-L2-relay-support IE, it means that the current cell supports an L2 U2N relay; otherwise, if the IE is absent from the SIB1, the current cell does not support an L2 U2N relay. When an SIB1 includes the SL-L3-relay-support IE, it means that the current cell supports an L3 U2N relay; otherwise, if the IE is absent from the SIB1, the current cell does not support an L3 U2N relay.

In some examples, the same IE may be used to indicate whether the current cell support L2 U2N relay or L3 U2N relay. For instance, the IE may be represented as “SL-relay-support IE=ENUMERATED {L2, L3}.” When an SIB1 includes the SL-relay-support IE having the ENUMERATED value of “L2,” it means that the current cell supports an L2 U2N relay. When the SIB1 includes the SL-relay-support IE having the ENUMERATED value of “L3,” it means that the current cell supports an L3 U2N relay. When the IE is absent from the SIB1, the current cell does not support any U2N relays.

In some examples, BS 402 may implicitly indicate whether a relay function is supported or not. For instance, when the parameter(s) associated with a sidelink relay, for example, a threshold to function as a relay node, is broadcasted, a UE may consider that the current cell supports the sidelink relay. When the parameter(s) associated with the sidelink relay is not broadcasted, the UE may consider that the current cell does not support the sidelink relay.

In some examples, a relay node may ignore a cellbar IE in the master information block (MIB) broadcast in a cell. The cellbar IE may indicate whether it is allowed to access the current cell.

Under certain scenarios, BS 402 may determine to switch UE 401A from the Uu link to a relay link. In operation 413, BS 402 may transmit an RRC reconfiguration message to UE 401A. In response to receiving the RRC reconfiguration message, UE 401A may start at least one of a physical layer timer (e.g., T310 as specified in 3GPP specifications) and a timer associated with measurement report triggering (e.g., T312 as specified in 3GPP specifications).

In some examples, the RRC reconfiguration message may indicate at least one candidate relay or cell. In operation 415, when the channel quality of a Uu link between UE 401A and BS 402 is equal to or less than a configured threshold, UE 401A may perform a discovery procedure. For example, UE 401A may select a target relay (e.g., relay node 401B) from the at least one candidate relay or cell based on certain criteria. UE 401A may perform a UE discovery procedure with relay node 401B. In response to discovering relay node 401B, UE 401A may transmit an RRC reconfiguration sidelink message to relay node 401B to establish a PC5 link with relay node 401B. In operation 417, UE 401A may establish a connection with BS 402 via relay node 401B. UE 401A thus can access BS 402 via relay node 401B.

In operation 419, in response to accessing BS 402 via relay node 401B, UE 401A may suspend the radio link monitoring (RLM) on the Uu link. In some examples, UE 401A may stop at least one of the physical layer timer (e.g., T310) and the timer associated with measurement report triggering (e.g., T312) when the at least one of the physical layer timer (e.g., T310) and the timer associated with measurement report triggering (e.g., T312) is running.

In some examples, stopping at least one of the physical layer timer (e.g., T310) and the timer associated with measurement report triggering when the at least one timer is running may include stopping the at least one timer in response to one of the following: (1) UE 401A has connected to BS 402 via relay node 401B; (2) the PC5 RRC connection between UE 401A and relay node 401B has been established; (3) UE 401A receives a reconfiguration message or an acknowledgement responsive to an indication of a successful relay selection to BS 402; and (4) UE 401A receives, from relay node 401B, an indication of a successful Uu bearer configuration for UE 401A.

In above operation (3), UE 401A may transmit an indication of a successful relay selection to BS 402 in response to selecting the target relay. The indication of the successful relay selection may be transmitted to BS 402 via an RRC message or a cell radio network temporary identifier (C-RNTI) medium access control (MAC) control element (CE). In response to receiving the indication, BS 402 may transmit a reconfiguration message or an acknowledgement to UE 401A via the relay.

It should be appreciated by persons skilled in the art that the sequence of the operations in exemplary procedure 400 may be changed and some of the operations in exemplary procedure 400 may be eliminated or modified, without departing from the spirit and scope of the disclosure.

In some embodiments, a procedure for releasing the PC5 link may be performed between a relay node and a remote UE. For example, after the receiver (e.g., relay node or remote UE) receives a signaling for releasing the PC5 link, the receiver may decide whether to release the PC5 link. It would be beneficial if the receiver can differentiate different cases of the release request. Embodiments of the present disclosure provide solutions to facilitate the release of the PC5 link. More details on the embodiments of the present disclosure will be illustrated in the following text in combination with the appended drawings.

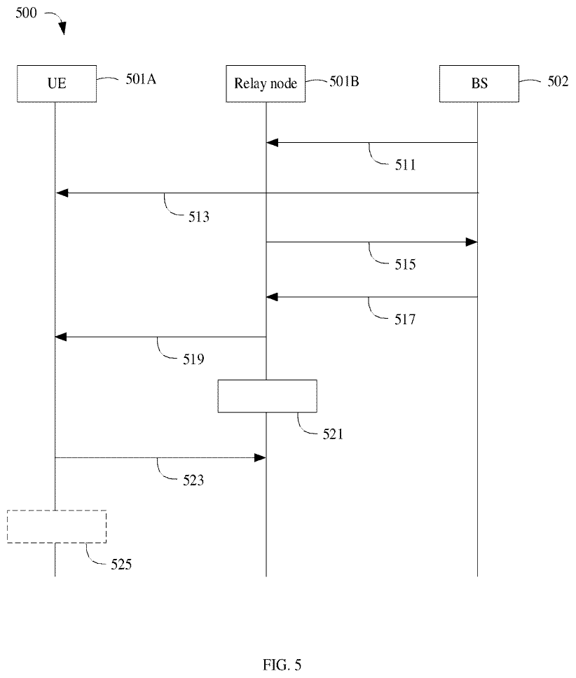

FIG. 5 illustrates a flow chart of an exemplary procedure 500 of wireless communications in accordance with some embodiments of the present disclosure. Details described in all of the foregoing embodiments of the present disclosure are applicable for the embodiments shown in FIG. 5.

In FIG. 5, UE 501A may access BS 502 (e.g., a cell of BS 502) via relay node 501B. In operations 511 and 513, BS 502 may transmit an RRC reconfiguration message to relay node 501B and UE 501A, respectively. In operation 515, relay node 501B may transmit measurement results to BS 502. Based on the measurement results, BS 502 may, in operation 517, transmit a handover command to relay node 501B.

In operation 519, relay node 501B may transmit a release request to UE 501A in response to receiving the handover command. In operation 521, relay node 501B may perform a handover procedure or a reestablishment procedure in response to receiving the handover command.

In some embodiments, relay node 501B may detect a radio link failure (RLF) on the Uu link between relay node 501B and BS 502. Relay node 501B may transmit a release request to UE 501A in response to detecting the RLF.

To facilitate the release procedure, the release request may include an indication to indicate different causes of the release request. For example, the release request may be one of: an RLF detection on the link between relay node 501B and BS 502 and a handover of relay node 501B from BS 502.

In response to receiving the release request, UE 501A may determine to release or keep the PC5 link between UE 501A and relay node 501B. For example, in response to receiving the release request, UE 501A may, in operation 523, transmit a response message which indicates to release or keep the PC5 link between UE 501A and relay node 501B. In some embodiments, UE 501A may first transmit a response message to keep the PC5 link. UE 501A may then determine to release the PC5 link, and may transmit, to relay node 501B, a request to release the PC5 link between UE 501A and relay node 501B in response to the response message indicating to keep the PC5 link.

In some embodiments, in response to determining to release the PC5 link between UE 501A and relay node 501B, UE 501A may perform a discovery procedure in operation 525 (denoted by the dotted block as an option). The discovery procedure may be performed based on a discovery configuration.

In some examples, for example, when the release request to UE 501A indicates either an RLF or a handover command, UE 501A may use a discovery configuration provided via dedicated signaling or an SIB. When UE 501A is out-of-coverage and cannot find any suitable relay or cell, UE 501A may not enter the idle state.

In some examples, the handover command to relay node 501B may include a discovery configuration. In response to receiving the handover command, relay node 501B may transmit the discovery configuration configured by the target cell to UE 501A, which can use the discovery configuration from the target cell during the discovery procedure.

It should be appreciated by persons skilled in the art that the sequence of the operations in exemplary procedure 500 may be changed and some of the operations in exemplary procedure 500 may be eliminated or modified, without departing from the spirit and scope of the disclosure.

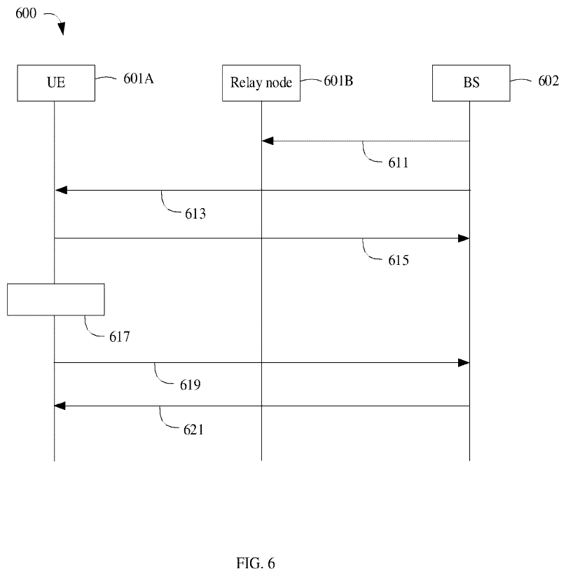

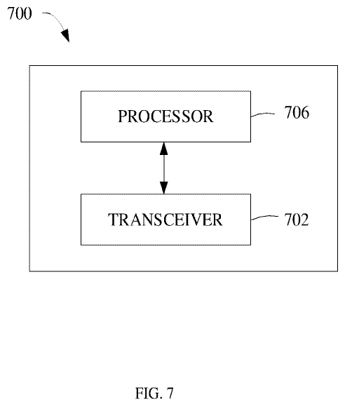

FIG. 6 illustrates a flow chart of an exemplary procedure 600 of wireless communications in accordance with some embodiments of the present disclosure. Details described in all of the foregoing embodiments of the present disclosure are applicable for the embodiments shown in FIG. 6.

In FIG. 6, UE 601A may access BS 602 (e.g., a cell of BS 602) via relay node 601B. In operations 611 and 613, BS 602 may transmit an RRC reconfiguration message to relay node 601B and UE 601A, respectively. In operation 615, UE 601A may transmit measurement results to BS 602.

In operation 617, UE 601A may declare an RLF. In some examples, UE 601A may declare the RLF in response to receiving a notification of the Uu RLF from relay node 601B. In some examples, the remote UE may declare the RLF in response to detecting a sidelink RLF, for example, an RLF on the link between UE 601A and relay node 601B.

In response to declaring the RLF or other conditions, UE 601A may initiate a reestablishment procedure. UE 601A may start a reestablishment initiation timer (e.g., T311 as specified in 3GPP specifications) in response to the initiation of the reestablishment procedure. UE 601A may select a suitable relay node or cell for reestablishment in response to the initiation of the reestablishment procedure.

In some examples, a suitable relay node may be a relay node for which a radio measurement at UE 601A fulfills a relay selection criterion. The relay selection criterion may be configured by BS 602 or predefined in, for example, a standard(s). In some examples, UE 601A may determine a relay node as a suitable relay node when a serving cell of this relay node supports a feature of interest to UE 601A or broadcasts an SIB of interest to UE 601A. For example, the feature of interest to UE 601A may include at least one of: a layer 2 (L2) relay feature, a multicast and broadcast service (MBS), a positioning service, and a V2X service. The SIB of interest to UE 601A may indicate that the serving cell of the relay node supports at least one of: the L2 relay feature, the MBS, the positioning service, and the V2X service. Other criteria that can be conceived of by persons skilled in the art or any combination of the criteria can be employed to determine a suitable relay node.

In some examples, in response to UE 601A selecting a relay node or cell for reestablishment, UE 601A may stop the reestablishment initiation timer. In some examples, UE 601A may stop the reestablishment initiation timer in response to one of the following conditions: (a) a PC5 RRC connection has been established between UE 601A and the selected relay node; (b) UE 601A receives a reconfiguration message or an acknowledgement message in response to an indication of successful relay selection to BS 602 (e.g., source BS of UE 601A); and (c) UE 601A receives, from the selected relay node, an indication of successful Uu bearer configuration for UE 601A.

In above operation (b), UE 601A may transmit an indication of a successful relay selection to BS 602 in response to selecting the target relay. The indication of the successful relay selection may be transmitted to BS 602 via an RRC message or a C-RNTI MAC CE. In response to receiving the indication, BS 602 may transmit a reconfiguration message or an acknowledgement to UE 601A via the relay.

The selected relay node or selected cell for reestablishment may be the same as or different from the source cell of UE 601A. In some examples, in response to a serving cell of the selected relay node or the selected cell for reestablishment being the source cell of UE 601A, UE 601A may retain a configuration configured by the source cell of UE 601A. In some examples, in response to a serving cell of the selected relay node or the selected cell for reestablishment not being the source cell of UE 601A, UE 601A may release the configuration configured by the source cell of UE 601A.

The configuration configured by the source cell of UE 601A may include, but not limited to, at least one of the following: a configuration for a special cell (SpCell) of UE 601A (e.g., “spCellConfig” as specified in 3GPP specifications); a configuration for a secondary cell (SCell) of a master cell group (MCG) of UE 601A; a configuration for delay budget reporting (e.g., “delayBudgetReportingConfig” as specified in 3GPP specifications); a configuration for overheating assistance information (e.g., “overheatingAssistanceConfig” as specified in 3GPP specifications); a configuration for in-device coexistence (IDC) problem assistance information (e.g., “idc-AssistanceConfig” as specified in 3GPP specifications); a Bluetooth name list (e.g., “btNameList” as specified in 3GPP specifications); a WLAN name list (e.g., “wlanNameList” as specified in 3GPP specifications); a sensor name list (e.g., “sensorNameList” as specified in 3GPP specifications); a configuration for a discontinuous reception (DRX) preference associated with the MCG of UE 601A (e.g., “drx-PreferenceConfig” for the MCG as specified in 3GPP specifications); a configuration for a bandwidth preference associated with the MCG of UE 601A (e.g., “maxBW-PreferenceConfig” for the MCG as specified in 3GPP specifications); a configuration for a carrier number preference associated with the MCG of UE 601A (e.g., “maxCC-PreferenceConfig” for the MCG as specified in 3GPP specifications); a configuration for a multiple input multiple output (MIMO) layer number preference associated with the MCG of UE 601A (e.g., “maxMIMO-LayerPreferenceConfig” for the MCG as specified in 3GPP specifications); a configuration for a minimum scheduling offset preference associated with the MCG of UE 601A (e.g., “minSchedulingOffsetPreferenceConfig” for the MCG as specified in 3GPP specifications); a configuration for a preference of leaving a radio resource control (RRC) connected state (e.g., “releasePreferenceConfig” as specified in 3GPP specifications); and a configuration for requesting an on-demand SIB (e.g., “onDemandSIB-Request” as specified in 3GPP specifications). Releasing the configuration for the SCell of the MCG of UE 601A may include releasing the MCG SCell(s) (if configured). In some examples, releasing the configuration may include suspend all radio bearers (RBs), except signaling RB 0 (SRB0).

In operation 619, UE 601A may transmit a reestablishment request to BS 602 via the selected relay node. For example, when the serving cell of the selected relay node belongs to BS 602, UE 601A transmit the reestablishment request to BS 602 via the selected relay node. In operation 621, the UE may receive a reestablishment message from BS 602 via the selected relay node.

It should be appreciated by persons skilled in the art that the sequence of the operations in exemplary procedure 600 may be changed and some of the operations in exemplary procedure 600 may be eliminated or modified, without departing from the spirit and scope of the disclosure.

FIG. 7 illustrates a block diagram of an exemplary apparatus 700 according to some embodiments of the present disclosure.

As shown in FIG. 7, the apparatus 700 may include at least one processor 706 and at least one transceiver 702 coupled to the processor 706. The apparatus 700 may be a BS, a relay node or a UE.

Although in this figure, elements such as the at least one transceiver 702 and processor 706 are described in the singular, the plural is contemplated unless a limitation to the singular is explicitly stated. In some embodiments of the present application, the transceiver 702 may be divided into two devices, such as a receiving circuitry and a transmitting circuitry. In some embodiments of the present application, the apparatus 700 may further include an input device, a memory, and/or other components.

In some embodiments of the present application, the apparatus 700 may be a UE. The transceiver 702 and the processor 706 may interact with each other so as to perform the operations with respect to the UEs described in FIGS. 1-6. In some embodiments of the present application, the apparatus 700 may be a relay node. The transceiver 702 and the processor 706 may interact with each other so as to perform the operations with respect to the relay nodes described in FIGS. 1-6. In some embodiments of the present application, the apparatus 700 may be a BS. The transceiver 702 and the processor 706 may interact with each other so as to perform the operations with respect to the BSs described in FIGS. 1-6.

In some embodiments of the present application, the apparatus 700 may further include at least one non-transitory computer-readable medium.

For example, in some embodiments of the present disclosure, the non-transitory computer-readable medium may have stored thereon computer-executable instructions to cause the processor 706 to implement the method with respect to the UEs as described above. For example, the computer-executable instructions, when executed, cause the processor 706 interacting with transceiver 702, so as to perform the operations with respect to the UEs described in FIGS. 1-6.

In some embodiments of the present disclosure, the non-transitory computer-readable medium may have stored thereon computer-executable instructions to cause the processor 706 to implement the method with respect to the relay nodes as described above. For example, the computer-executable instructions, when executed, cause the processor 706 interacting with transceiver 702, so as to perform the operations with respect to the relay nodes described in FIGS. 1-6.

In some embodiments of the present disclosure, the non-transitory computer-readable medium may have stored thereon computer-executable instructions to cause the processor 706 to implement the method with respect to the BSs as described above. For example, the computer-executable instructions, when executed, cause the processor 706 interacting with transceiver 702, so as to perform the operations with respect to the BSs described in FIGS. 1-6.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
access a base station (BS) via a Uu link;
in response to a channel quality of the Uu link being less than a threshold, access the BS via a relay node; and
stop at least one of a physical layer timer or a timer associated with measurement report triggering if the at least one of the physical layer timer or the timer associated with the measurement report triggering is running.

2. The UE of claim 1, wherein to stop the at least one of the physical layer timer or the timer associated with the measurement report triggering is in response to one of:
the UE has connected to the BS via the relay node;
a PC5 radio resource control (RRC) connection has been established between the UE and the relay node;
receiving a reconfiguration message or an acknowledgement responsive to an indication of successful relay selection to the BS; or
receiving, from the relay node, an indication of successful Uu bearer configuration for the UE.

3. The UE of claim 1, wherein the at least one processor is configured to cause the UE to receive a release request from the relay node, wherein the release request indicates one of: a radio failure link (RLF) detection on a link between the relay node and the BS, or a handover of the relay node from the BS.

4. The UE of claim 3, wherein in response to receiving the release request, the at least one processor is configured to cause the UE to transmit a response message to the relay node, wherein the response message indicates to release or keep a PC5 link between the UE and the relay node.

5. The UE of claim 4, wherein the at least one processor is configured to cause the UE to transmit, to the relay node, a request to release the PC5 link between the UE and the relay node in response to the response message indicating to keep the PC5 link between the UE and the relay node.

6. A method performed by a user equipment (UE), comprising:
initiating a reestablishment procedure;
starting a reestablishment initiation timer in response to the initiation of the reestablishment procedure; and
selecting a relay node or cell for reestablishment.

7. The method of claim 6, wherein the selected relay node is a relay node for which a radio measurement at the UE fulfills a relay selection criterion.

8. The method of claim 6, further comprising stopping the reestablishment initiation timer in response to at least one of:
the relay node for the reestablishment has been selected;
a PC5 radio resource control (RRC) connection has been established between the UE and the selected relay node;
receiving a reconfiguration message or an acknowledgement responsive to an indication of successful relay selection to a source base station (BS) of the UE; or
receiving, from the selected relay node, an indication of successful Uu bearer configuration for the UE.

9. The method of claim 6, wherein a serving cell of the selected relay node supports a feature of interest to the UE or broadcasts a system information block (SIB) of interest to the UE.

10. The method of claim 9, wherein the feature of interest to the UE comprises at least one of a layer 2 (L2) relay feature, a multicast and broadcast service (MBS), a positioning service, or a vehicle-to-everything (V2X) service; or
wherein the SIB of interest to the UE indicates that the serving cell of the selected relay node supports at least one of the L2 relay feature, the MBS, the positioning service, or the V2X service.

11. The method of claim 6, further comprising:
retaining a configuration configured by a source cell of the UE in response to a serving cell of the selected relay node or the selected cell for the reestablishment being the source cell of the UE.

12. The method of claim 11, further comprising:
releasing the configuration configured by the source cell of the UE in response to the serving cell of the selected relay node or the selected cell for the reestablishment not being the source cell of the UE.

13. The method of claim 12, wherein the configuration configured by the source cell of the UE comprises at least one of:
a first configuration for a special cell (SpCell) of the UE;
a second configuration for a secondary cell (SCell) of a master cell group (MCG) of the UE;
a third configuration for delay budget reporting;
a fourth configuration for overheating assistance information;
a fifth configuration for in-device coexistence (IDC) problem assistance information;
a Bluetooth name list;
a WLAN name list;
a sensor name list;
a sixth configuration for a discontinuous reception (DRX) preference associated with the MCG of the UE;
a seventh configuration for a bandwidth preference associated with the MCG of the UE;
an eighth configuration for a carrier number preference associated with the MCG of the UE;
a ninth configuration for a multiple input multiple output (MIMO) layer number preference associated with the MCG of the UE;
a tenth configuration for a minimum scheduling offset preference associated with the MCG of the UE;
an eleventh configuration for a preference of leaving a radio resource control (RRC) connected state; or
a twelfth configuration for requesting an on-demand system information block (SIB).

14. The method of claim 6, further comprising:
receiving an indication in a system information block (SIB) as to whether a relay function is supported.

15. A relay node, comprising:
at least one memory; and
at least one processor coupled with the at least one memory and configured to cause the relay node to:
transmit a release request to a user equipment (UE) that accesses a base station (BS) via the relay node, and the release request indicates one of a radio failure link (RLF) detection on a link between the relay node and the BS, or a handover of the relay node from the BS.

16. The relay node of claim 15, wherein, in response to the release request transmitted to the UE, the at least one processor is configured to cause the relay node to receive a response message from the UE, the response message indicating to release or keep a PC5 link between the UE and the relay node.

17. The relay node of claim 16, wherein the at least one processor is configured to cause the relay node to receive, from the UE, a request to release the PC5 link between the UE and the relay node in response to the response message indicating to keep the PC5 link between the UE and the relay node.

18. A processor for wireless communication, comprising:
at least one controller coupled with at least one memory and configured to cause the processor to:
initiate a reestablishment procedure;
start a reestablishment initiation timer in response to the initiation of the reestablishment procedure; and
select a relay node or cell for reestablishment.

19. The processor of claim 18, wherein the selected relay node is a relay node for which a radio measurement at a user equipment (UE) fulfills a relay selection criterion.

20. The processor of claim 18, wherein the at least one controller is configured to cause the processor to stop the reestablishment initiation timer in response to at least one of:
the relay node for the reestablishment has been selected;
a PC5 radio resource control (RRC) connection has been established between a user equipment (UE) and the selected relay node;
receiving a reconfiguration message or an acknowledgement responsive to an indication of successful relay selection to a source base station (BS) of the UE; or
receiving, from the selected relay node, an indication of successful Uu bearer configuration for the UE.

21. The method of claim 6, further comprising receiving an indication of whether a relay function is supported or not supported in a system information block (SIB).
